(19) United States
(12) Patent Application Publication
(10) Pub. No.: US 2006/0075122 A1
(43) Pub. Date: Apr. 6, 2006

(54) Method and system for managing cookies according to a privacy policy

(76) Inventors: Helena Lindskog, Karlstad (SE); Johan Hjelm, Stockholm (SE); Peter Thornqvist, Saltsjoo-Boo (SE); Mikael Nilsson, Jarfalla (SE)

Correspondence Address: ERICSSON INC., 6300 LEGACY DRIVE, M/S EVR C11, PLANO, TX, 75024, US

(21) Appl. No.: 10/519,606

(22) PCT Filed: Jun. 19, 2003
(86) PCT No.: PCT/SE03/01067

§ 371 Date: Jul. 25, 2005

(30) Foreign Application Priority Data
Jul. 2, 2002 (SE) 0202057-6

(51) Int. Cl. G06F 15/16

(52) U.S. Cl. 709/228

(57) ABSTRACT

The present invention involves a user agent (100) requesting a cookie-associated resource over Internet from a content provider (200) on behalf of a user. In response thereto, the content provider (200) transmits a privacy policy file, describing the content provider's policy regarding usage of cookies and privacy data in connection with the resource, to the user agent (100). The agent (100) then generates a cookie receipt specifying whether the user accepts the policy and, thus, accepts that the content provider sets a cookie on the user equipment (300) The receipt is transmitted to the content provider (200), e.g. in the HTTP header of a get resource message. In case of a positive receipt, the content provider (200) provides the requested resource and sets the cookie. If a negative receipt, a cookie-less version of the resource if provided to the user equipment (300).

### TECHNICAL FIELD

The present invention generally refers to management of cookies in data processing systems, and in particular to confirming user acquaintance of cookie associated privacy policies in such systems.

### BACKGROUND

The usage of Internet has increased tremendously in the last few years and has now become everyman's tool. Basically, Internet is a set of computer networks joined together by means of gateways handling data transfer and using different protocols specifying how data can be sent and received.

Today, several different applications are available for the users of Internet, such as using Internet as an information database, communication with other users by means of email, chat and instant messages. Also commerce is conducted on Internet with several companies offering products and services online and banking institutions allowing their customers to perform different transactions and payments over the Internet.

The currently most commonly employed method of transferring data over the Internet is to use the World Wide Web (W3), or simply the Web, although other information transferring resources exist, e.g. File Transfer Protocol (FTP) and Gopher. In this Web environment, servers and user equipment, such as a computer or mobile station, uses the Hypertext Transfer Protocol (HTTP) for handling the transfer of data files. The information in these data files is formatted for presentation to a user in a standard page description language, the Hypertext Markup Language (HTML) and its counterparts for the Mobile Internet, i.e. using thin clients, e.g. mobile user equipment and units, extensible HTML (XHTML) and Compact HTML (CHTML). In order to locate a server or a Web resource on the Internet, a Universal Resource Location (URL) is used. URL provides a universal, consistent method for finding and accessing resources. In order to access a resource, the user typically uses a Web browser. In a typical resource requesting scenario, the user requests a resource by clicking on a link or by entering information with a keyboard. The browser catches the information and translates it into an HTTP request. The browser then forwards this HTTP request to the Web server of the resource or content provider. Once the server has processed the request, it sends back a response to the browser. The browser translates this response to a human-readable format and presents it to the user. In this request-response scenario, the interface between the user and the browser is the standardized language HTML (XHTML/CHTML). Between the browser and the server the communication protocol HTTP is used.

In the scenario above, when the Web server returns the HTTP response object to the user (to the user's browser) it may also send a piece of state information, called a cookie, in the HTTP protocol header. A cookie may be transient, i.e. will only persist while a current browser session is open, or persistent. A persistent cookie is, once it is received by the browser, stored on the user equipment and will remain available even if the user closes the browser. Once a cookie is sent to user equipment, the server expects the cookie to be returned (replayed) in the HTTP header of subsequent messages sent from the browser to the server. Such a cookie inclusion in the HTTP header of messages from the browser is done without the user's awareness. Cookies are useful tools for creating user-friendly Web applications because they provides a way for storing user preferences and information so users do not have to redo tasks, such as registering on a company's Web site. For example, a shopping application can store information (in a “shopping bag”) about the currently selected items.

However, the storage of a cookie may be an unauthorized storage of data on another user's equipment (computer or mobile unit). In addition, the cookie could be used for tracking the user and his/her requests for information from server sites without the user's knowledge or permission.

A solution to the user privacy problems with cookies could be that the browser rejects storage of cookies on the user equipment. Browsers typically accept all cookies as default, but often may be configured for disabling the cookie acceptance entirely. A problem with such a solution is that some Web sites may not function properly when the acceptance of cookies is disabled by the browser. Thus, the user may not be able to access such Web sites without having cookies accepted by the browser.

In order to enable Web sites to express privacy practices, e.g. regarding their usage of cookies, in a standard form the Platform for Privacy Preferences Project (P3P) was launched in 1997. Regarding cookies, P3P specifies that a cookie that is to be included in the HTTP header and transmitted from a content provider to user equipment should be accompanied by or associated with a privacy policy. Such a policy typically specifies information about the company setting or providing the cookie, how the cookie is used by the company, etc.

U.S. patent application US 2002/0156781 A2 discloses a method and apparatus for managing cookies in a computer system. Cookies are received during a browser program session. The cookies are only stored in a temporary data store within the computer system for a duration of the browser program session. The cookies stored in the temporary data store may be displayed in response to a signal to terminate the session. Cookies are then selectively stored in a persistent storage based on user input.

### SUMMARY

Although according to the Platform for Privacy Preferences Project (P3P) recommendations, a privacy policy describing the usage of cookies is transmitted to the user equipment this does not per se guarantees that the user actually has acquainted the policy. Thus, none of the prior art solutions provide a mechanism for the cookie setting content or resource provider to know that the user indeed has surveyed the privacy policy.

The present invention overcomes these and other drawbacks of the prior art arrangements.

It is a general object of the present invention to enable a content or resource provider to know that a user has acquainted a privacy policy associated with a resource requested by the user.

It is another object of the invention to provide a requested resource from a content provider to a user in response to a privacy policy receipt specifying whether the user accepts a privacy policy associated with the resource.

Yet another object of the invention is to provide a possibility for a user to specify how a content provider should manage personal data and cookies.

A further object of the invention is to provide methods, devices and systems well adapted for usage in a P3P agreement procedure.

These and other objects are met by the invention as defined by the accompanying patent claims.

Briefly, the present invention involves a user requesting a cookie-associated resource from a content provider over a network, such as Internet. The resource could be a Web page, video, picture or audio file that, upon delivery to the user's user equipment (e.g. computer or mobile unit), is accompanied by a set-cookie command, i.e. a cookie is provided and stored on the user equipment. In response to the request, a user agent associated with or provided in the user equipment receives a privacy policy from the content provider. The policy includes the content provider's policy regarding usage of cookies and privacy data in connection with the resource or service that the user has requested, e.g. during a P3P agreement procedure. The user agent then generates a cookie receipt specifying whether the user accepts the privacy policy and, thus, accepts that the content provider sets a cookie on his/her user equipment. The receipt is then transmitted to the content provider, which provides the requested resource and sets a cookie if the receipt is positive or provides a cookie-less version, if available, to the user equipment in case of a negative cookie receipt.

The invention is well adapted for usage in a P3P agreement procedure. Such procedure, generally starts with the user desiring a resource from a content provider, e.g. by clicking on a link on a Web site or entering an Universal Resource Location (URL) of the resource on a Web browser on his/her user equipment. An associated user agent then requests a privacy policy reference file from the content provider. The reference is a file that ties privacy polices, including policies of management of cookies, to the resources and services provided by the content provider. When the user agent receives the requested reference from the content provider it identifies the URL of the privacy policy file associated with the desired resource. A request policy message is then transmitted to the content provider that transmits the privacy policy file. The user agent could then display the privacy policy for the user by means of a viewer and a screen of the user equipment. In addition, the user is urged to either accept or reject, e.g. by clicking on a button or entering some input data, the policy.

Alternatively, the user agent could have access to user preferences, a document specifying a set of rules of managing privacy data, including cookies, which the user has accepted. The user agent then compares the received privacy policy file with the preferences. If the policy fulfills the user preferences a positive cookie receipt is generated, whereas a negative receipt is generated if the privacy policy does not fulfill or match the preferences. The receipt is then preferably included in the HTTP (Hypertext Transfer Protocol) header of a get resource message transmitted from the user agent to the content provider.

In case of a positive receipt, the user agent also replays (provides) any cookies already stored on the user equipment and being associated with the presently requested resource. However, if the receipt is negative, any such stored and resource-associated cookies are preferably removed from the user equipment. In addition, if the content provider (fraudulently) sets or provides a cookie, in spite of the receipt specifying that the user rejects setting cookies on his/her computer, any such set-cookie command is ignored by the user agent.

The user agent could be implemented in software, hardware or a combination thereof in the user equipment, e.g. in the Web browser of the user equipment. Alternatively, the agent could be provided as a plug-in for the browser. Also a user agent arranged elsewhere, e.g. in a proxy server, is possible. In such a case, any user preferences could be stored in the server together with the user agent. The proxy server could then manage P3P agreement procedures on behalf of several different users. The server is preferably provided by a third party, to which the user has a service agreement (subscription), e.g. a network operator or service provider in case of mobile user equipment.

The invention offers the following advantages:
Provides mechanism enabling content providers to know that a user has acquainted a privacy policy associated with a requested resource;
Allows users opportunity to accept or reject a content provider's policy regarding usage of cookies and privacy data before a cookie is set; and
Is well adapted for usage in a P3P agreement procedure for providing resources from content providers to users over Internet.

Other advantages offered by the present invention will be appreciated upon 25 reading of the below description of the embodiments of the invention.

### SHORT DESCRIPTION OF THE DRAWINGS

The invention together with further objects and advantages thereof, may best be understood by making reference to the following description taken together with the accompanying drawings, in which:

FIG. 1 is a schematic overview of an example of a data processing system according to the present invention during a P3P agreement procedure;

FIG. 2 is a block diagram of an embodiment of a user agent according to the present invention;

FIG. 3 is a block diagram of another embodiment of a user agent according to the invention;

FIG. 4 is an illustration of an embodiment of user equipment to which the teaching of the present invention can be applied;

FIG. 5 is an illustration of another embodiment of user equipment to which the teaching of the present invention can be applied;

FIG. 6 is a block diagram of an embodiment of a content provider according to the present invention;

FIG. 7 is a flow diagram of a cookie managing method according to the present invention;

FIG. 8 is a flow diagram illustrating the receipt-generating step of FIG. 7 in more detail;

FIG. 9 is a flow diagram illustrating an additional step of the cookie managing method according to the present invention;

FIG. 10 is a flow diagram illustrating additional steps of the cookie managing method according to the present invention; and

FIG. 11 is a flow diagram of a resource providing method according to the present invention.

### DETAILED DESCRIPTION

Throughout the drawings, the same reference characters will be used for corresponding or similar elements.

In the last years the privacy and security awareness of computer users and those that are employing the Internet has increased tremendously and is today a prime issue for many users. For example, with today's technique it may be possible to map a user's Internet application pattern, i.e. registering the Web sites he/she frequently visits, by using a state object, a cookie, specifying, among others, the Universal Resource Locations (URLs) of the Web sites the user has visited. Many users find this violating his/her privacy, which might lead to consequences for how they will use the Internet. In many countries these privacy issues have been discussed thoroughly and the demands on the content providers, i.e. those providing Web sites and are setting cookies, have increased. For example, it has been suggested that a content provider is not allowed to set a cookie without first providing a cookie privacy policy, informing the user about the cookie and how it is used [1].

The present invention provides means for enabling a content provider to know that a user actually has acquainted the provided privacy policy and thus has accepted, or rejected, that cookies may be set.

The present invention is well adapted for use in the Platform for Privacy Preferences Project (P3P), but not limited thereto. P3P provides, e.g. means for Web sites to express their privacy practices, including usage and management of cookies, in a standard format that can be easily interpreted by users, allowing the content providers to inform the users about the site practices. Thus, P3P provides a mechanism for ensuring that users can be informed about privacy policies before they release personal (privacy) information. Further information regarding P3P and user privacy can be found in [2, 3].

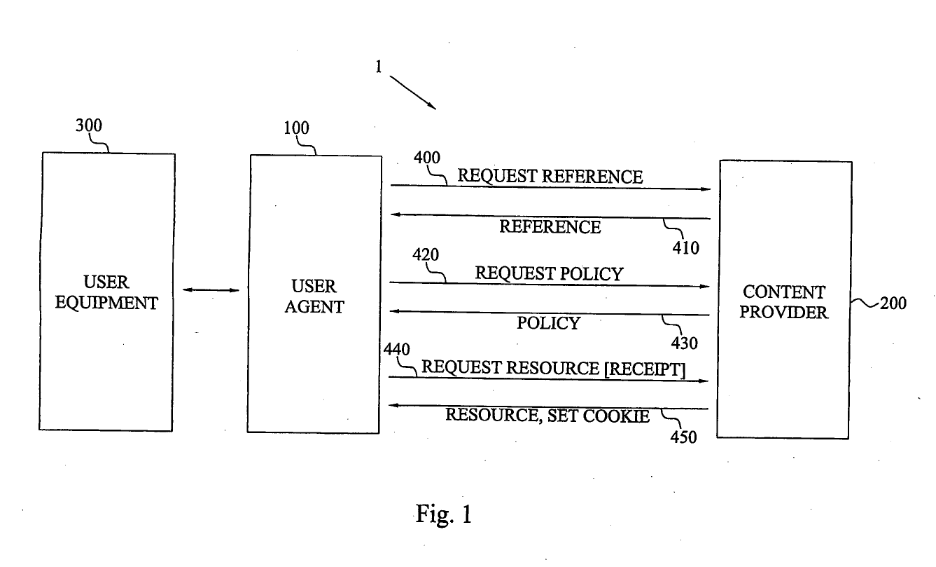

The present invention will now be discussed with reference to a P3P agreement procedure in connection to the data processing system of FIG. 1. The P3P agreement concerns the privacy practices of providing a resource from a content or service provider 200 to a user's user equipment 300 over a network, such as the Internet. In this connection, a resource is a network data object or service that can be identified by a URL, e.g. a Web site or page, video, picture, audio file, etc.

In the following the resource is identified as a resource associated with a cookie. As the person skilled in the art knows, once such a cookie-associated resource is provided to a user equipment 300, the content provider 200 traditionally also provides or sets a (persistent) cookie in the user equipment 300. More information about cookies and setting cookies can be found in [4].

The data processing system of FIG. 1 includes, in addition to the user equipment 300 and content provider 200, a user agent 100. This user agent 100 mediates interactions with the content provider 200 on behalf of the user. The agent 100 may be implemented in the user equipment 300, e.g. in the Web browser of the user equipment 300, provided as a plug-in to the Web browser of the user equipment 300. Alternatively, the agent 100 could be implemented in a proxy server, located elsewhere, which is discussed in more detail below.

The P3P agreement procedure generally starts when a user requests a cookie-associated resource from a content provider 200, e.g. by clicking on a link on a Web site presented on the Web browser of the user equipment 300 or by entering, using a keyboard or similar user input interface, the URL of the resource on the Web browser. The user agent 100 associated with the user's user equipment 300 transmits, in response to the resource request, a request 400 for a privacy policy reference file associated with the URL of the cookie-associated resource. This reference file states what privacy policy, or sometimes policies that apply to a specific resource (URL or set of URLs) provided by the content provider 300. In other words, the policy reference file is used to associate P3P privacy polices with certain regions of URL-space of a content provider 300. The policy reference file is an eXtensible Markup Language (XML) with namespaces file that can specify the privacy policy for a single Web site, portion thereof or several sites. The reference file typically specifies the URL where a policy file is found, URLs or regions of URL-space covered (and/or not covered) by the policy, cookies that are (and/or are not) covered by the policy, etc. The policy reference file is preferably located in a predefined “well-known” location, but a document could indicate the location of the policy reference file through an HyperText Markup Language (HTML) link tag, eXtensible HTML (XHTML) link tag or an HyperText Transfer Protocol (HTTP) header.

The preferred predefined known location of a policy reference file is available on a site at the path /w3c/p3p.xml. Thus, if the domain of the requested resource is www.werespectyou.com the reference file is found on www.werespectyou.com/w3c/p3p.xml. In such a case, the user agent 100 identifies the domain of the requested cookie-associated resource and adds the suffix (/w3c/p3p.xml) to get the location of the reference file.

Alternatively, or in addition, any document retrieved by HTTP may point to a policy reference file though the use of a P3P response header. In such a case the HTTP header could include this extra information:

P3P: policyref=“http://www.werespectyou.com/P3P/PolicyReferences.xml”

The user agent 100 then identifies the URL of the reference file from such an HTTP header in a document transmitted from the content provider 200 to the user agent 100. A further possibility is to indicate the location of the relevant P3P policy reference file with an embedded HTML/XHTML link tag. An example of the link tag is:

<link rel=“P3Pv1”href=“http://www.werespectyou.com/P3P/PolicyReferences.xml”>

In such a case, the user agent 100 identifies the URL of the reference file from the tag.

Once, the user agent 100 has identified the URL of the reference file, from the well-known location, HTTP header and/or HTML/XHTML link tag, it requests the policy reference file 400, typically, from the content provider 200. The requested reference file 410 is then provided to the user agent 100. Herebelow follows an example of such a policy reference file:

<META xmlns=”http.//www.w3.org/2002/01/P3Pv1”>

<POLICY-REFERENCES>

<EXPIRY max-age=”86400”/>

<POLICY-REF about=”P3P/default_policy.xml”>

<INCLUDE>/*</INCLUDE>
<EXCLUDE>/register/index.html</EXLUDE>

</POLICY-REF>
<POLICY-REF about=”P3P/register_policy.xml”>

<INCLUDE>/register/index.html/INCLUDE>
<COOKIE-INCLUDE/>

</POLICY-REF>
<POLICY-REF about=”P3P/cookie_policy.xml”>

<COOKIE-INCLUDE>/info/*</COOKIE-INCLUDE>

</POLICY-REF>

</POLICY-REFERENCES>

</META>

The reference file example above indicates that all the cookies set by the /register/index.html page will be described in the register_policy.xml privacy policy file whereas all the cookies set by the /info/* part of the site will be described by the cookie_policy.xml privacy policy file. More information about reference files can be found in [2, 3].

The user agent 100 then identifies the P3P privacy policy associated with the desired cookie-associated resource from the reference file, or the cookie privacy policy associated with the resource, if the cookie policy is provided as an extra policy file. P3P privacy policies use an XML with namespaces encoding of the P3P vocabulary to typically provide contact information for the legal entity (content provider 200) making the representation of privacy practices in a policy, enumerate the types of data or data elements collected and explain how the data will be used. Thus, a (cookie) privacy policy preferably covers any data that is stored in the cookie or linked via the cookie. The policy further preferably reference all purposes associated with data stored in the cookie or enabled by the cookie. Also any data/purpose stored or linked via the cookie should be found in the cookie privacy policy. In addition, if the linked data is collected by HTTP then the policy that covers the get or fetch request should also cover the data collection. For example, when WeRespectYou asks customers to fill out a form with their name, billing and shipping information, the P3P privacy policy that covers the form submittal should disclose that WeRespectYou collects this data and explain how it is used. If WeRespectYou sets a cookie so that it can recognize its customers and observe their behavior on its Web site, it should have a separate policy for this cookie. However, if the cookie is also linked to the user's name, billing and shipping information, perhaps so WeRespectYou can generate custom catalogue pages based on where the customers live, then that data should also be disclosed in the cookie privacy policy.

Once, the relevant privacy policy is identified, the user agent 100 requests the policy file 420 based on the URL of the policy as found in the policy reference file. The requested policy 430 is then provided to the user agent 100. A typical example of a privacy policy dealing with cookies is found herebelow:

<POLICIES xmlns=”http://www.w3.org/2002/01P3Pv1”>

<POLICY name=”forShoppers”

discuri=”http://www.werespectyou.com/Privacy/PrivacyPracticeShop.html”

xml : lang=”en”>

<ENTITY>

<DATA-GROUP>

<DATA ref=”#business.name”>WeRespectYou</DATA>
<DATA ref=”#business.contact-info.postal.street”>23 St Street</DATA>
<DATA ref=”#business.contact-info.postal.city”>Birmingham</DATA>
<DATA ref=”#business.contact-info.postal.stateprov”>MI</DATA>
<DATA ref=”#business.contact-info.postal.postalcode”>48009</DATA>
<DATA ref=”#business.contact-info.postal.country”>USA</DATA>
<DATA ref=”#business.contact-info.online.email=”mail@wry.com</DATA>
<DATA ref=”#business.contact-

info.telecom.telephone.intcode”>1</DATA>

<DATA ref=”#business.contact-

info.telecom.telephone.loccode”>123</DATA>

<DATA ref=”#business.contact-

info.telecom.telephone.nummer”>123456</DATA>

</DATA-GROUP>

</ENTITY>
<ACCESS><contact-and-other/></ACCESS>
<DISPUTES-GROUP>

<DISPUTES resolution-type=”independent”

service=”http://www.PrivacySeal.example.org”
short-description=”PrivacySeal.example.org”>
<IMG src=”http://www.PrivacySeal.org.example.org/Logo.gif”

alt=”PrivacySeal's logo”/>

<REMEDIES><correct/></REMEDIES>

</DISPUTES>

</DISPUTE-GROUP>
<STATEMENT>

<CONSEQUENCE>

We tailor our site based on your past visits.

</CONSEQUENCE>
<PURPOSE><tailoring/><develop/></PURPOSE>
<RECIPIENT><ours/></RECIPIENT>
<RETENTION><stated-purpose/></RETENTION>
<DATA-GROUP>

<DATA ref=”#dynamic.cookies”>

<CATEGORIES><state/></CATEGORIES>

</DATA>
</DATA ref=”#dynamic.miscdata”>

<CATEGORIES><preference/></CATEGORIES>

</DATA>

</DATA-GROUP>

</STATEMENT>

</POLICY>

</POLICIES>

For information about policies reference is made to [2, 3].

In an embodiment of the invention, once the user agent 100 receives the relevant requested privacy policy file it may display the policy on a user interface, e.g. a screen, of the user equipment 300. The user can then survey and read the policy. In addition, the user agent 100 displays a question, e.g. in a pop-up window, on the screen of the equipment 300, urging the user to accept or reject the presented privacy policy. The user can then select accept (reject) the policy and that cookies discussed in the policy is set on the user's user equipment 300 by clicking on the accept (reject) button of the pop-up window, by pressing a key of a keyboard associated with the user equipment 300, etc. Based on this user input, the user agent 100 generates a cookie policy receipt, which is discussed in more detail below.

In another embodiment of the invention, the user has specified user preferences, a document specifying a set of rules of managing privacy data, including cookies, which the user has accepted. The user preferences may be stored in a machine-readable format called A P3P Preference Exchange Language (APPEL) specifically designed for this purpose. The preferences define the privacy settings of the user, e.g. by specifying under what conditions cookies may be set on his/her user equipment 300. The user agent 100 then preferably has, or has access to, an administration tool so that the user can enter his/her privacy settings. In a typical implementation, the user agent 100 may have access to default user preferences that include the default privacy settings before the user actually starts using the user agent 100. The default preference is then preferably personalized during usage. Thus, the user agent “learns” while the user equipment is being used, e.g. by presenting questions to a user with a “remember this decision” check box. This usually works like:
1. The user tries to do something, e.g. filling in his address on a registration form on a Web site.
2. The user agent 100, or some program in the user equipment 300, asks a question (“Do you want to fill in address information?”), followed by a check box, indicating “remember this decision”.
3. If the check box is checked, the decision is stored, i.e. the user preferences are updated accordingly.

During usage the preferences will become more and more personalized based on the user's earlier decisions regarding managing privacy information and cookies.

In this embodiment, the user agent 100 is implemented to compare the received privacy policy with the user preferences. Based on this comparison, i.e. whether the privacy policy fulfills or matches the user preferences, a cookie policy receipt is generated similar to above.

The policy receipt, thus, specifies whether the user accepts or rejects the privacy policy and that a cookie, associated with the resource, is set. The receipt is, thus, generated based directly (using a user input) or indirectly (through a comparison between the privacy policy and user preferences) on the user's decision. The generated policy receipt is then transmitted from the user agent 100 to the content provider 200 that is to provide the resource and set cookie. The receipt could be transmitted as a dedicated message to the content provider 200 or included in one of the messages of the P3P agreement signaling between the user agent 100 and the content provider 200. In a preferred embodiment, the policy receipt is included in the HTTP header of the resource get or fetch message 440 transmitted from the user agent 100 to the content provider 200. An example of such a receipt including HTTP header of a get message is as follows:
GET /index.php HTTP/1.1
HOST: www.werespectyou.com
P3P: cookie-receipt-nok

In the example above, the user has, directly or indirectly, accepted the privacy policy and that a cookie to be set. The corresponding HTTP header if the user rejects cookie setting on his/her user equipment 300 is:
GET /index.php HTTP/1.1
HOST: www.werespectyou.com
P3P: cookie-receipt-nok

If the user accepts the (cookie) privacy policy and that a cookie is set, in addition to transmitting a positive policy receipt, the user agent 100 replays or provides any cookies associated with the requesting resource and already stored on the user equipment 300. Such a cookie has already been provided during an earlier request of the same resource (i.e. from the same URL). Once the content provider 200 receives the receipt, e.g. in the header of the get resource message, it provides the resource 450 to the user equipment 300 (possible through the user agent 100). In addition it sets a cookie, or updates (resets) a replayed cookie.

If, however, the user does not accept the policy and that a cookie is sent, no stored resource-associated cookies are preferably replayed. In addition, the user agent 100 preferably removes any such stored resource-associated cookies from the user equipment 300. The user agent 100 also transmits the (negative) cookie receipt to the content provider 200, which is, thus, informed that the user does not accept the privacy policy or that cookies should be set. The content provider 200 can now provide the requested resource, but in a cookie-less version. In some applications, the resource might be a non-optimal version of the usual cookie-associated resource, with limited functions and depersonalized appearance. It could also be possible that the resource cannot be provided if a cookie is not used. In such a case, the content provider 200 preferably transmits a message informing the user agent 100 and user accordingly. If the content provider 200 fraudulently tries to set a cookie, although the cookie receipt specifies that the user rejects any cookie setting, the user agent 100 is preferably implemented to ignore any such received (faulty) set-cookie command.

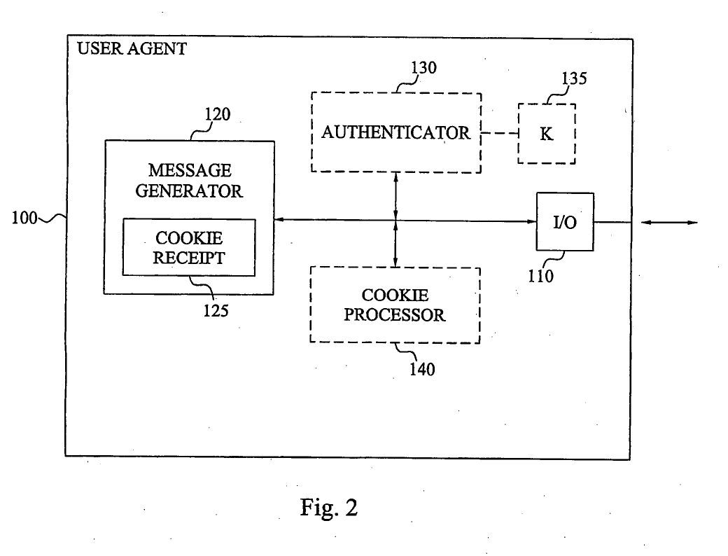

FIG. 2 illustrates a block diagram of an embodiment of a user agent 100 according to the present invention. The user agent 100 comprises an input and output (I/O) unit 110 for managing communication with associated user equipment and a content provider. A message generator 120 of the user agent 100 generates messages transmitted to the content provider, e.g. the get reference file, get policy file and get resource messages transmitted by the I/O unit 110 to the content provider during a P3P agreement procedure. A cookie receipt generator 125 is implemented in the user agent 100, e.g. in the message generator 120 or connected or associated thereto. In the embodiment of user agent 100 of FIG. 2, the receipt generator 125 composes the cookie privacy receipt based on a user-input signal provided from the I/O unit 110. Once composed, the receipt is provided to the message generator 120 and included in a message, preferably the HTTP header of the get resource message, provided to the I/O unit 110 and forwarded to the content provider.

When the I/O unit 110 receives a cookie or privacy police from a content provider it presents the privacy policy to a user. In an embodiment of the invention, the user agent 100 is equipped with a viewer (not illustrated) adapted for presenting policies to users. Alternatively, or in addition, the user agent 100 can forward the policy to another viewer implemented in the associated user equipment, e.g. using a viewer of the Web browser. The viewer presents the policy on a user interface, e.g. a screen, of the user equipment. In addition, the viewer also preferably urges the user to accept or reject the privacy policy, e.g. by clicking on a button of a pop-up window, entering data (for example, Y(es) or N(o)) using a keyboard. The user-input signal is then provided to the I/O unit 110 of the user agent 100, which forwards the signal to the cookie receipt generator 125. The generator 125 then composes the receipt based on this input signal.

A security operation or authenticating unit 130 may optionally be provided in the user agent 100 for authenticating or signing the cookie receipt, allowing the content provider to identify from whom the receipt is derived. The authenticating unit 130 may append an authentication tag to the receipt. The tag could be a digital signature added to the receipt using a private signing key 135 of an asymmetric key pair. The associated public verification key together with a certificate on the public key is stored at a trusted party. Also message authentication, e.g. using symmetric keys 135, may be used to authenticate and identity the origin of the cookie receipt. A hash function value of the request resource message, or a portion thereof, possibly also including additional data, e.g. URL of the resource, the present date, could be used for signing purposes.

If the user rejects the policy and does not want any cookies to be set, the (negative) input signal is also preferably forwarded from the I/O unit 110 to a cookie processor 140 of the user agent 100. This cookie processor 140 is implemented for deleting any cookies already stored on the user equipment and which are associated with the requested resource. Such cookies can originate from an earlier request of the resource and were, thus, set during such an earlier resource request procedure. It may be possible that the user equipment did not have a user agent 100 according to the invention at this earlier request procedure and that the user then did not have an opportunity to view the policy and transmit a negative cookie receipt to the content provider. Alternatively, the privacy policy of the resource might have changed from a policy that the user accepted at the earlier request to a new policy that the user does not want to accept. In addition, the user's point of view regarding setting cookies could have changed between the two occasions. Instead of deleting any stored cookies, the cookie processor 140 could generate a cookie delete signal that is transmitted to some cookie managing program (e.g. the Web browser) of the user equipment, which then deletes the relevant cookie(s) based on the delete signal. If a negative cookie receipt, the I/O unit 110 preferably also ignores a set-cookie command from a (fraudulent) content provider.

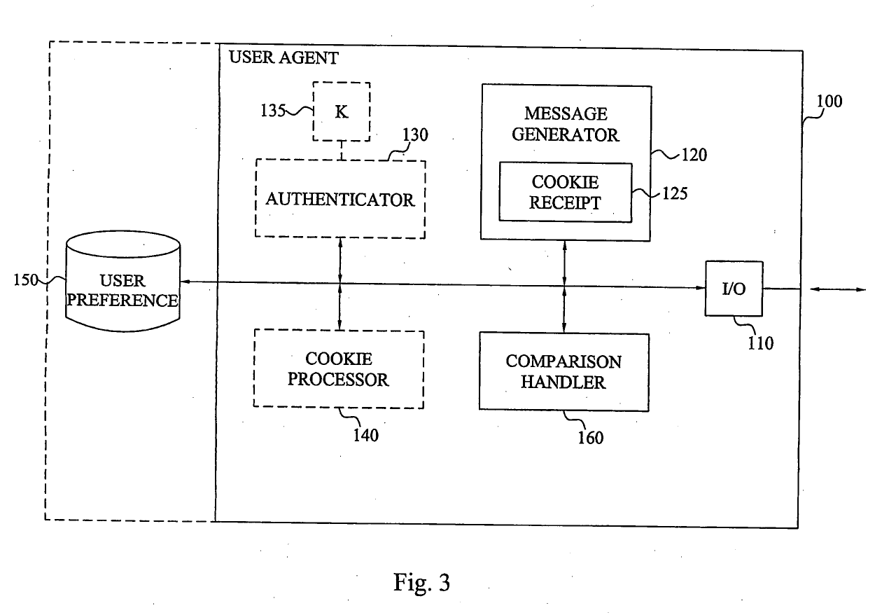

FIG. 3 illustrates a block diagram of another embodiment of a user agent 100 according to the invention. The user agent 100 of FIG. 3 includes a comparison unit 160 that is adapted for comparing a (cookie) privacy policy received from the I/O unit 110 with user preferences 150. The user preferences 150 could be stored on the user equipment and provided to the comparison unit 150 through the I/O unit 110. Alternatively, the user preferences 150 are stored in connection with the user agent 100, e.g. together with the user agent 100 in a proxy, or associated thereto. The comparison unit 160 compares the privacy policy with the preferences 150 and investigates whether the policy fulfills or matches the user preferences 150. Based on this comparison, the comparison unit 160 generates and transmits a comparison signal to the cookie receipt generator 125. The generator 125 then generates the receipt in response to this received signal and provides the cookie receipt to the message generator 120. The receipt is preferably included in the HTTP header of the get resource message generated by the message generator 120 and provided to the I/O unit 110, possibly after being signed by the authentication unit 130, for transmission to the content provider. Also an optional cookie processor 140 may be implemented in the user agent 100 for deleting stored cookies in case of negative cookie receipts, similar to the discussion above with reference to FIG. 2. The means of the user agent 100 in FIGS. 2 and 3, i.e. the I/O unit 110, message generator 120, cookie receipt generator 125, authenticating unit 130, cookie processor 140 and comparison unit 160, can be implemented in software, in hardware or as a combination of software and hardware.

Also a user agent being essentially a combination of the functionalities of the user agent of FIG. 2 and FIG. 3, respectively, is possible. In such a user agent, a comparison unit compares the received privacy policy with user preferences. If the policy fulfills the preferences, a positive comparison signal is transmitted to the generator that generates the (positive) cookie receipt. However, if the policy does not fulfill the user preferences, the policy is displayed on the user output interface (screen). The user agent, viewer portion of user agent, or external viewer, could present the complete privacy policy for the user or could be implemented for presenting only those portions of the policy that does not fulfill the user preferences. In addition, the viewer urges the user to input (click button or push key(s)) whether he/she accepts the policy. The I/O unit then forwards the user-input signal to the generator that generates the cookie receipt in response to this signal. Thus, in this embodiment the user gets an opportunity to accept a policy that actually does not fulfill his/her preferences. This may be advantageous if the user in some applications can consider accepting polices that he/she usually does not accept.

The user agent could also be implemented for performing the comparison functionality of FIG. 3 or the display functionality of FIG. 2. The user could then specify for the user agent which operation mode it presently is to use.

In a basic embodiment of the invention, the cookie receipt generally is as follows:
P3P: cookie-receipt-ok for a positive cookie receipt
P3P: cookie-receipt-nok for a negative cookie receipt

It may, however, be possible to use a more precise division in receipts that is based on one hand whether the user accepts the policy and on the other how the user accepts/rejects the policy. Table 1 below summaries the four possible cookie receipts and there consequences.

TABLE 1

| | | | Action by |
|---|---|---|---|
| | | Action by | content |
| Cookie receipt | Meaning | user agent | provider |
| P3P: cookie- | Policy is presented | Replay of stored | Send resource |
| receipt-user- | for user, user | cookies | and set cookie. |
| ok | accepts policy. | | |
| P3P: cookie- | Policy fulfills user | | |
| receipt-prefs- | preferences. | | |
| ok | | | |
| P3P: cookie- | Policy is presented | Remove stored | No cookies |
| receipt-user- | for user, user | cookies, ignore | should be set. |
| nok | rejects policy. | set cookie. | Provide cookie- |
| | | | less resource. |
| P3P: cookie- | Policy does not | | |
| receipt-prefs- | fulfill user | | |
| nok | preferences. | | |

If the receipt is positive, the user agent, in addition to transmitting the cookie receipt and resource get message, should replay (provide) any cookies stored on the user equipment and being associated with the requested resource. The content provider should, once the positive receipt is received, provide the requested resource and set any cookies. In the case of positive receipt based on a comparison, the user has actually not read the privacy policy but (indirectly) accepts it through the user agent. In such a case, the policy can optionally be presented on the user equipment so that the user can read it in clear text.

If the receipt is negative the user agent, in addition to transmitting the cookie receipt and resource get message, could remove any cookies stored on the user equipment and being associated with the requested resource. The content provider should not, once the negative receipt is received, set any cookies but provide a cookie-less version (if available) of the resource to the user equipment. In addition, a note can be presented to the user (on the user equipment) indicating that since the user refused cookies, the service/resource will not function fully or at all.

The user agent can be implemented in software, in hardware or a combination of software and hardware. For example implemented as software in a Web browser application, or associated thereto, in the user equipment or provided as a plug-in to the Web browser.

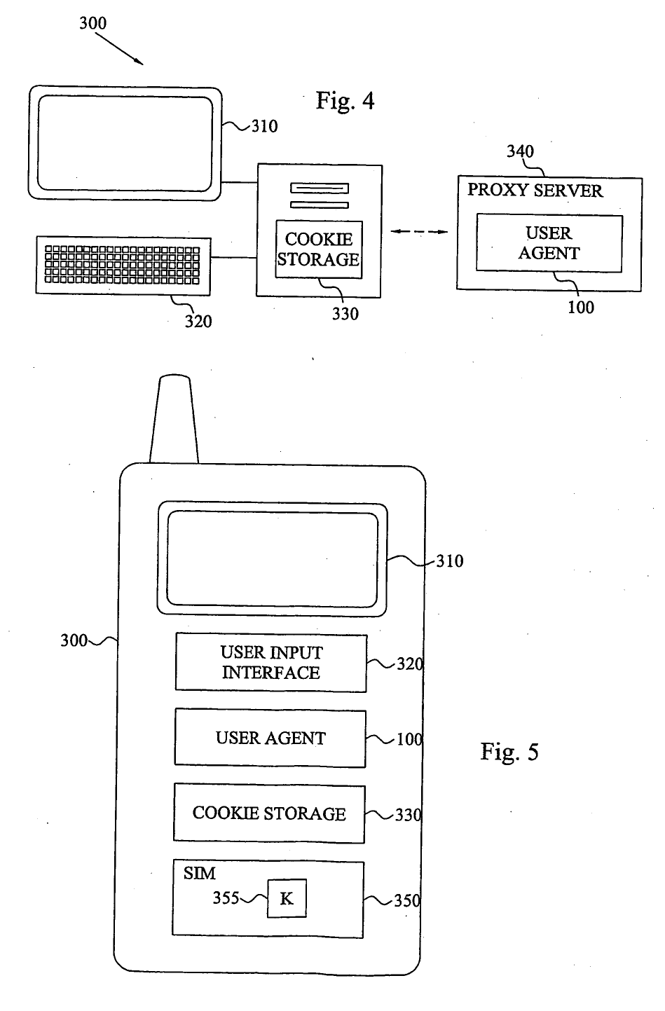

FIG. 4 illustrates an embodiment of user equipment 300 with access to a user agent 100 according to the present invention. In this embodiment the user equipment is illustrated as a computer 300, including a user output interface, i.e. screen 310 for displaying a privacy policy, a user input interface, i.e. keyboard 320, and a hard disk. In FIG. 4, the user agent 100 is implemented in a proxy server 340 located elsewhere, but directly or indirectly connected or associated with the computer 300. In FIG. 4, when a policy is accepted by the user, e.g. by clicking on an accept button or through a comparison to user preferences, a cookie associated with the requested resource is set (provided) by the content provider and stored in a memory 330 of the computer 300. Also the user preferences may be stored on the computer 300. However, it might be advantageous to store user preferences in connection to the user agent 100, i.e. on the proxy server 340. This server 340 could be managed by a third party, which may hold preferences of many users. In such a case, the preferences could be provided in a database in the proxy server 340 or associated thereto. One user agent 100 could then manage P3P agreement procedures with content providers on behalf of many users. The user agent 100 could instead be implemented in the computer 300, e.g. in the hard disk of the computer 300.

FIG. 5 illustrates another embodiment of user equipment 300 provided with user agent 100 according to the present invention. The user equipment is represented as a mobile unit or station 300, including a mobile telephone, PDA (Personal Digital Assistant) or other mobile user equipment. The mobile unit 300 generally comprises a screen 310 for presenting a received privacy policy, user input interface 320, e.g. a keyboard, and a network subscriber identity module (SIM) 350 issued by a (network) service provider or operator, e.g. standard SIM cards used in Global System for Mobile Communications (GSM) mobile telephones, Universal Mobile Telecommunications System (UMTS) SIM (USIM), Wireless Identity Module (WIM), Internet Multimedia Services Identity Module (ISIM) cards and Universal Integrated Circuit Card (UICC) modules. In FIG. 5 the user agent 100 is implemented in the mobile unit 100. However, it may possible to provide the user agent 100 in a proxy server, as was discussed above. In such a case, the proxy could be managed by the (network) service provider issuing the SIM 350, such as a network operator with which the user has a service agreement (subscription). The user preferences are preferably stored in the proxy server if the server holds the user agent 100. Otherwise the user preferences is preferably stored in the mobile unit 300. For thin user equipment, e.g. mobile units, with limited storage capability compared to computers, the preferences could be stored in some proprietary, optimized binary code. The mobile unit 300 also includes a memory 330 for storing any (accepted) cookies.

If the cookie receipt is to be authenticated or signed before sending it from the mobile unit 300 to the content provider, a key 355 associated with the SIM 350 could be reused for these signing purposes. Also an Authentication and Key Agreement (AKA) module provided on the SIM and comprising algorithms, e.g. the GSM A3/A8 AKA algorithms, for operating on data sent/received by the mobile unit 300 can be employed for authenticating, with the key 355, the cookie receipt. Alternatively, a dedicated authentication unit could be used instead of the AKA module.

The user agent 100 could be provided as software, hardware, or a combination thereof in the mobile unit 300. Furthermore, the user agent 100 can be implemented in an application environment provided by an application toolkit associated with the SIM 350, e.g. SIM Application Toolkit (SAT) or UMTS SAT (USAT). The SIM 350 may be pre-manufactured with the user agent 100 or the user agent 100 may be securely (preferably authenticated and encrypted) downloaded from a network node, associated with the network operator or service provider issuing the SIM 350. Commands, associated with the SIM—mobile unit interface, are used for downloading and implementing the user agent 100 in the application environment. The same commands can also be used for subsequently receive and implement upgrades of the user agent 100.

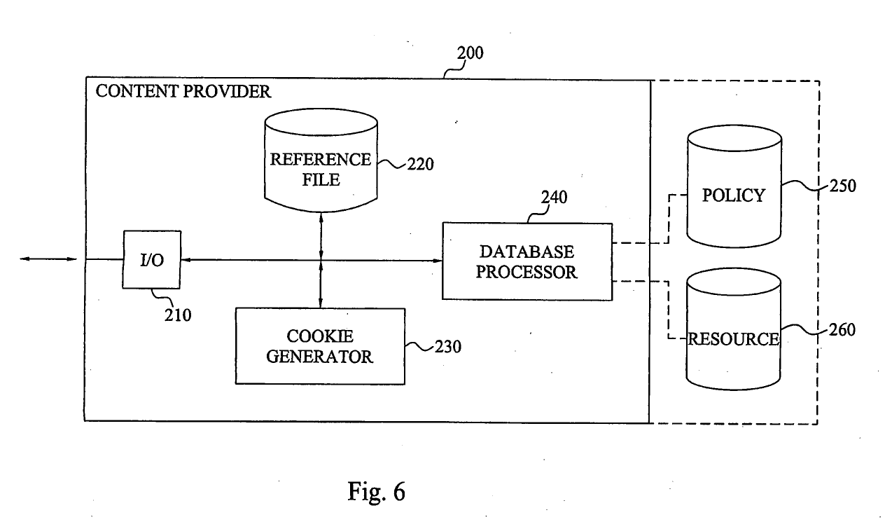

FIG. 6 illustrates a block diagram of an embodiment of a content or service provider 200 according to the present invention. The content provider 200 comprises an input and output (I/O) unit 210 managing communication with a user agent and especially adapted for receiving get reference file, get policy file, get resource (with cookie receipt) messages and for transmitting a reference file, a policy file and a resource to an user agent/user equipment. The content provider 200 preferably includes a predefined storage location for its reference file(s) 220. This could be the well-known location discussed in the foregoing. However, it could be possible to use another storage location and then provide the URL of the reference file to a requesting user agent included in a HTTP header or through a HTML/XHTML link tag. A database processor 240 is provided in the content provider 200 for providing a requested privacy policy file stored in a memory location 250. The policy file(s) 250 could be stored in the content provider 200 or stored elsewhere, but preferably accessible for the processor 240. The database processor 240 preferably also has access to a storage location of the resources and services 260 that the content provider offers and provides. This resource storage 260 could be a database of the Web pages, video, picture, and audio files that the content provider 200 transmits to a requesting user agent. The resource storage 260 could be provided in the content provider 200, associated thereto or provided from some other party on behalf of the content provider 200. The resource storage 260 preferably includes at least two versions of a resource, with one fully functional cookie-associated version and one, possible not optimal, version that is not associated with cookies.

When the I/O unit 210 receives a get resource message with a positive cookie receipt, the processor 240 provides the cookie-associated resource version to the I/O unit 210 that forwards it to the requesting user agent (user equipment). In addition, a cookie engine or generator 230 sets a cookie on the user equipment, by providing a set-cookie command or message to the I/O unit 210 for forwarding it to the user equipment. However, if the receipt is a negative cookie receipt, i.e. specifying that the requesting user does not accept that cookies are set, the cookie generator 230 should not provide any set-cookie command. In addition, the cookie-less version of the resource, if available, should be provided to the user equipment. Optionally, the content provider 200 could transmit a note to the user equipment indicating that since cookies were rejected, the requested resource cannot be provided or only a less than optimal version of the resource can be provided. The means of the content provider 200 in FIG. 6, i.e. the I/O unit 210, cookie generator 230 and database processor 240 can be implemented in software, in hardware or as a combination of software and hardware.

The content provider 200 could be a computer or server hosting a Web site of a company, e.g. a company offering services and resources, selling goods, presenting information, such as text, pictures, video and audio, on its Web site. A content provider 200 could also be any origin server managing or hosting a Web site or home page of a company, association, user etc., that sets cookies.

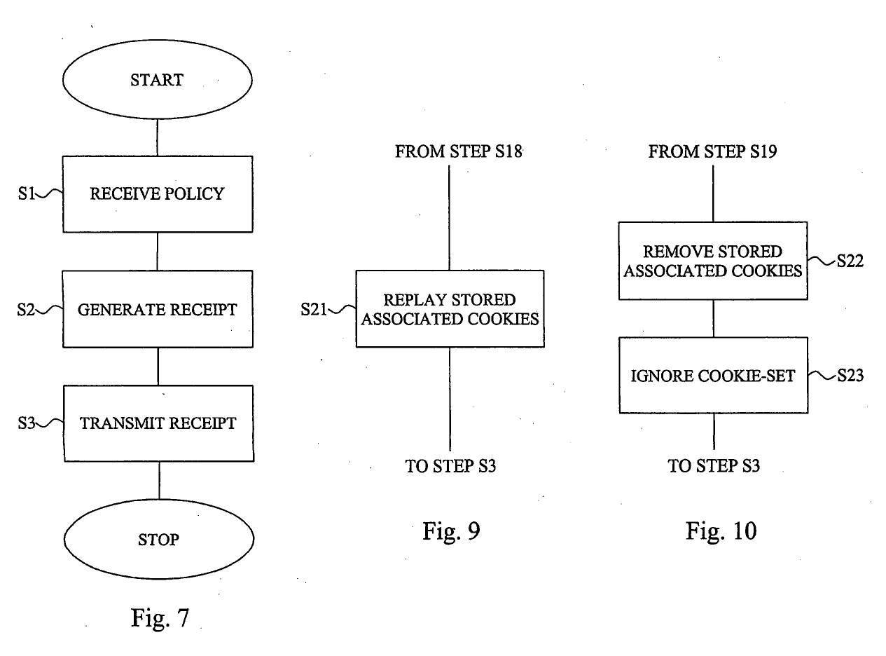

FIG. 7 is a flow diagram summarizing the cookie management method according to the present invention. In step S1, a user agent associated with user equipment receives a privacy policy from a content provider. The policy includes the content provider's policy regarding usage of cookies and privacy data in connection with a cookie-associated resource or service that the user has requested, e.g. during a P3P agreement procedure. The user agent generates a cookie receipt in step S2. This receipt specifies whether the user associated with the user agent accepts the policy and, thus, accepts that a cookie is set. This cookie receipt is transmitted to the content provider in step S3. The method then ends.

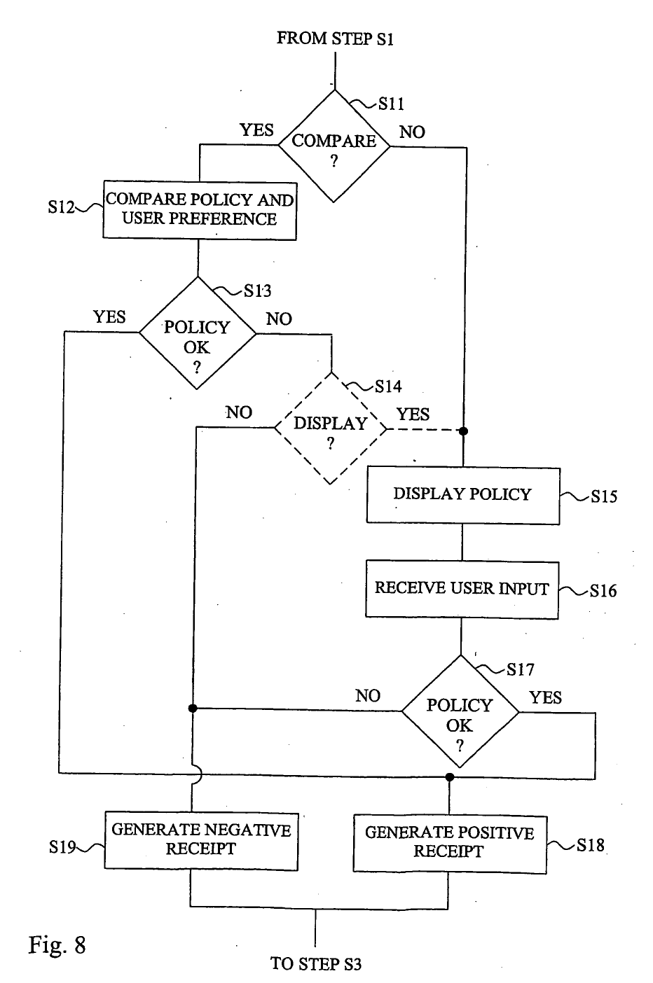

FIG. 8 is a flow diagram illustrating the cookie-receipt-generating step of FIG. 7 in more detail. Starting with step S11, here it is concluded whether the user agent is adapted for comparing polices with user preferences. A user agent could have functionality for generating the receipt based on a comparison, not based on a comparison, or there may be a user choice between generating the receipt based on a comparison or not on a comparison. If it is concluded that a comparison should be performed, the privacy policy is compared to the user preferences in step S12. In step S13 it is checked whether the policy fulfills or matches the user preferences. If the policy fulfills the preferences, a positive Lo cookie receipt is generated in step S18. However, if the policy does not fulfill the preferences, a negative cookie receipt could be generated in step S19. Optionally, if the policy does not match the preferences the policy, the user agent could check if the policy should be displayed in step S14. If yes, the privacy policy is presented on the user equipment, such as on a screen, for the user in step S15. The user is also urged to accept or reject the policy by clicking on a button or entering some information (e.g. Y or N). In step S16, the user agent receives the user-input signal and the signal is investigated in step S17 to conclude if the user accepts or rejects the policy. If accepted, a positive cookie receipt is generated in step S18 but if rejected, a negative receipt is generated in step S19. If it is concluded in step S11 that the user agent does not have functionalities for performing a comparison or the user has specified that no comparison should be performed, the privacy policy is displayed in step S15. Thereafter the method follows to step S16, S17 and S18 or S19, as discussed above. The method then continues to step S3.

FIG. 9 illustrates an additional step of the cookie managing method of FIG. 7 in case of a positive receipt. If a positive receipt is generated, any cookie(s) associated with the requested resource and already stored on the user equipment is replayed (provided) to the content provider in step S21. The method then continues to step S3.

FIG. 10 illustrates additional steps of the cookie managing method of FIG. 7 in case of a negative receipt. If a negative receipt is generated, any cookie(s) associated with the requested resource and already stored on the user equipment are preferably removed from the user equipment in step S22. No cookies should be replayed and a possible cookie-set command from a content provider should be ignored in step S23. The method then continues to step S3.

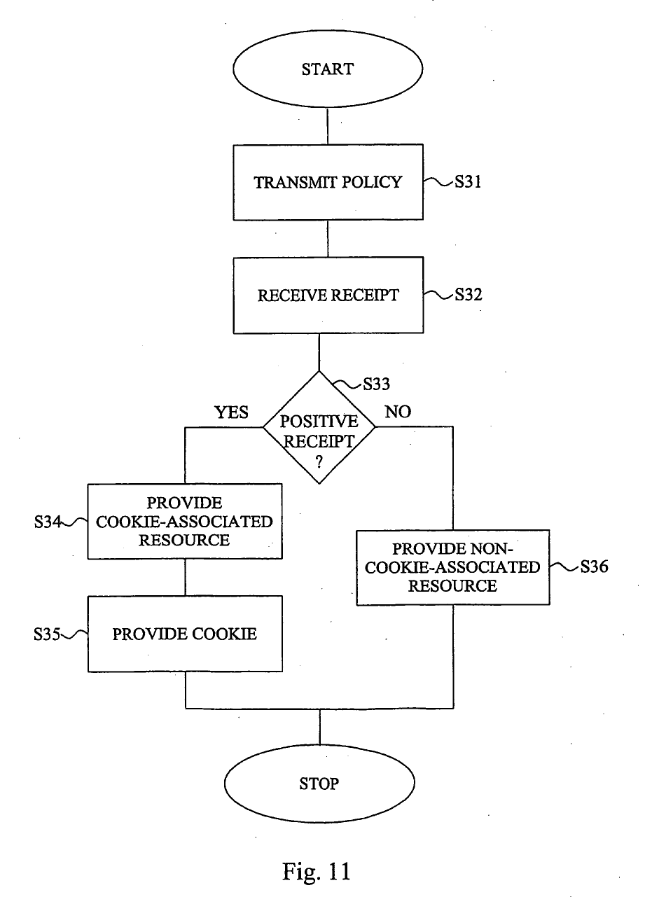

FIG. 11 illustrates a flow diagram of a method of providing a resource from a content provider to requesting user equipment over a network, e.g. Internet, according to the present invention. In step S31 the content provider transmits a privacy policy to a user agent associated with the user equipment. The policy includes the content provider's policy regarding usage of cookies and privacy data in connection with the cookie-associated resource or service that the user has requested, e.g. during a P3P agreement procedure. In step S32 the content provider receives a cookie receipt specifying whether the user accepts the policy and, thus, accepts that cookies are set on his/her user equipment. The policy receipt is investigated in step S33. If the policy as checked in step S33 is positive, the content provider transmits the requested cookie-associated resource in step S34. In addition, a cookie is provided or set in step S35. However, if the receipt is negative, the content provider could provide an non-cookie-associated version, if available, of the resource in step S36. No cookie should be set. In addition, the content provider may transmit a note, specifying that since the user rejected that a cookie is set, no resource or only a non-optimal version thereof can be provided. The method then ends.

It will be understood a person skilled in the art that various modifications and changes may be made to the present invention without departure from the scope thereof, which is defined by the appended claims.

### REFERENCES

1 Directive 2002/58/EC of the European Parliament and of the Council of 12 Jul. 2002, Official Journal of the European Communities, L 201/37, 31 Jul. 2002.
2 Lindskog H and Lindskog S, Web site privacy with P3P®, Wiley Publishing, Inc., 2003, the United States of America.
3 World Wide Web consortium (W3C), W3C Technical Reports and Publications, The Platform for Privacy Preferences 1.0 (P3P1.0) Specification, http://www.w3.org/TR/P3P.
4 Persistent Client State HTTP Cookies, http://wp.netscape.com/newsref/std/cookie_spec.html.

1-24. (canceled)

25. A method of managing cookies in a data processing system, said method comprising the steps of:
a user agent requesting a resource associated with a cookie from a content provider;
said user agent transmitting, in response to reception of a privacy policy associated with said cookie, a cookie-policy receipt to said content provider, said cookie-policy receipt specifying whether a user associated with said user agent accepts that said content provider provides said cookie to user equipment associated with said user agent.

26. The method according to claim 25, further comprising the step of including said cookie-policy receipt in a resource fetch message transmitted from said user agent to said content provider.

27. The method according to claim 25, further comprising the steps of:
said user agent comparing said received privacy policy with a user preference, said user preference specifying a cookie privacy policy accepted by said user; and
said user agent generating said cookie-policy receipt based on said comparison.

28. The method according to claim 27, wherein, if said received privacy policy does not match said user preference, said method further comprising the steps of:
said user agent presenting said received privacy policy for said user on said user equipment; and
said user agent generating, in response to a user-input signal, said cookie-policy receipt.

29. The method according to claim 25, further comprising the steps of:
said user agent presenting said received privacy policy for said user on said user equipment; and
said user agent generating, in response to a user-input signal, said cookie-policy receipt.

30. The method according to claim 25, further comprising the step of authenticating said cookie-policy receipt with an authentication key associated with said user agent.

31. The method according to claim 25, wherein, if said cookie-policy receipt specifies that said user does not accept that said content provider provides said cookie to said user equipment, said method comprising the step of removing a stored cookie associated with said requested resource from a storage memory in said user equipment.

32. The method according to claim 25, wherein, if said cookie-policy receipt specifies that said user does not accept that said content provider provides said cookie to said user equipment, said method comprising the step of ignoring a cookie request command transmitted from said content provider to said user agent.

33. A method of providing cookies in a data processing system, wherein a user agent requests a resource associated with a cookie from a content provider, said method comprising the steps of:
transmitting a privacy policy associated with said cookie to said user agent; and
said content provider providing, in response to reception of a cookie-policy receipt from said user agent, said cookie to user equipment associated with said user agent if said cookie-policy receipt specifies that a user associated with said user agent accepts that said content provider provides said cookie to said user equipment.

34. The method according to claim 33, wherein said cookie-policy receipt is received in a resource fetch message transmitted from said user agent.

35. The method according to claim 33, wherein, if said cookie-policy receipt specifies that said user accepts that said content provider provides said cookie to said user equipment, said method comprising the step of providing said cookie-associated resource.

36. The method according to claim 33, wherein said cookie-policy receipt is generated based on a comparison between said received privacy policy and user preference that specifies a cookie privacy policy accepted by said user.

37. A user agent provided in a data processing system for requesting a resource associated with a cookie from a content provider, said user agent comprising:
means for transmitting, in response to reception of a privacy policy associated with said cookie, a cookie-policy receipt to said content provider, said cookie-policy receipt specifying whether a user associated with said user agent accepts that said content provider provides said cookie to user equipment associated with said user agent.

38. The user agent according to claim 37, wherein said transmitting means includes said cookie-policy receipt in a resource fetch message transmitted to said content provider.

39. The user agent according to claim 37, further comprising:
means for comparing said received privacy policy with user preference, said user preference specifying a cookie privacy policy accepted by said user; and
means for generating, connected to said comparing means, said cookie-policy receipt based on said comparison.

40. The user agent according to claim 39, further comprising means for presenting said received privacy policy for said user on said user equipment if said privacy policy does not match said user preference, said generating means being adapted for generating said cookie-policy receipt in response to a user input signal.

41. The user agent according to claim 37, further comprising:
means for presenting said received privacy policy for said user on said user equipment; and
means for generating said cookie-policy receipt in response to a user input signal.

42. The user agent according to claim 37, further comprising means for authenticating said cookie-policy receipt with an authentication key associated with said user agent.

43. The user agent according to claim 37, further comprising means for removing a stored cookie associated with said requested resource from a storage in said user equipment if said cookie-policy receipt specifies that said user does not accept that said content provider provides said cookie to said user equipment.

44. A content provider adapted for providing a requested resource associated with a cookie to a user agent in a data processing system, said content provider comprising:
means for transmitting, in response to a resource request from said user agent, a privacy policy associated with said cookie to said user agent; and
means for providing, in response to a cookie-policy receipt transmitted from said user agent, said cookie to user equipment associated with said user agent, said cookie providing means providing said cookie if said cookie-policy receipt specifies that a user associated with said user agent accepts that said content provider provides said cookie to said user equipment.

45. The content provider according to claim 44, wherein said cookie-policy receipt is received in a resource fetch message transmitted from said user agent.

46. The content provider according to claim 44, further comprising means for providing said cookie-associated resource if said cookie-policy receipt specifies that said user accepts that said content provider provides said cookie to said user equipment.

47. The content provider according to claim 44, wherein said cookie-policy receipt is generated based on a comparison between said received privacy policy and user preference that specifies a cookie privacy policy accepted by said user.

48. A system for managing cookies in a data processing system comprising a user agent that requests a resource associated with a cookie from a content provider, said system comprising:
means for providing a privacy policy associated with said cookie;
means for transmitting a cookie-policy receipt, said receipt transmitting means being responsive to said privacy policy; and
means for providing said cookie in response to said cookie-policy receipt specifying that a user associated with said user agent accepts that said content provider provides said cookie to user equipment associated with said user agent.
